(19) United States
(12) Patent Application Publication
(10) Pub. No.: US 2003/0122961 A1
(43) Pub. Date: Jul. 3, 2003

(54) Method for de-interlacing video information

(75) Inventor: Renxiang Li, Lake Zurich, IL (US)

Correspondence Address: FITCH EVEN TABIN AND FLANNERY, 120 SOUTH LA SALLE STREET, SUITE 1600, CHICAGO, IL, 60603-3406, US

(73) Assignee: Motorola, Inc.

(21) Appl. No.: 10/034,358

(22) Filed: Dec. 28, 2001

(51) Int. Cl. H04N 11/20

(52) U.S. Cl. 348/448; 348/452

(57) ABSTRACT

A process to convert frames of interlaced video information into two corresponding frames of progressive video information. Pursuant to this process, a portion of the interlaced video information is selected and utilized to interpolate additional video information. Overlapped region partition is applied to that additional information wherein each region is repeatedly compared against a plurality of regions contained in the unselected interlaced video information. By using the motion determination information gained through these comparisons, a plurality of specific pixels within the unselected interlaced video information can be identified for each pixel within the interpolated additional video information and the identified pixel values utilized to calculate a replacement pixel value for each pixel within the interpolated additional video information. The resultant progressive frame is dependent upon the selected portion of interlaced video information and the replacement pixel values, and occasionally is also dependent upon the interpolated video information.

### TECHNICAL FIELD

This invention relates generally to video information and particularly to de-interlacing video information.

### BACKGROUND

Many kinds of electronically portrayed video images (including analog, digital and high-definition television signals) are comprised of sequentially interlaced image fields wherein a field comprises data that represents a scene at one point in time and a next sequentially presented field presents that same scene only slightly temporally displaced forward in time. Typically, an interlaced video frame comprises two fields that are of opposite polarity, an even/bottom field and an odd/top field with one leading the other in time. For example, as portrayed in FIG. 1, a first grouping of data 11 is comprised of a plurality of lines 12 wherein each line is comprised of a plurality of pixels. A second grouping of data 13 is similarly comprised of a plurality of lines 14 wherein each line is again comprised of a plurality of pixels. These two groupings 11 and 13 can be interleaved to create a single frame 15 of interlaced data. The interlaced data itself simply comprises the lines 12 from the first grouping of data 11 as interleaved with the lines 14 of the second grouping of data 13. Because of this orientation scheme, the lines 12 of the first field of data are often referred to as “top” or “odd” lines and the lines 14 of the second field of data are often referred to as “bottom” or “even” lines, respectively. Compared to a full frame 15 of successive lines without missing lines of pixels, each field (odd or even) is sub-sampled by a factor of two in the vertical dimension. Such a sub-sampling can introduce aliasing for interlaced video data.

It is often necessary to process the interlaced video images (for example, to display interlaced video images on a progressive scanned display device or to scale or warp the interlaced video images for purposes such as image editing and composition). Such activities often give rise to a need to de-interlace sequentially presented fields into progressive frames.

Simple de-interlacing comprises constructing a progressive scanned image at the point in time where the field image is sampled. The scan lines of the present field are retained and only those missing lines (the line positions that comprise the field of opposite polarity) need to be estimated. Unfortunately, simply interleaving two fields of an interlaced frame to formulate a progressive frame will often cause serious visual artifacts due to the fact that the two fields are sampled at different times and object boundaries in the frame may misalign due to object motion during the temporal window.

Various prior art approaches to field based de-interlacing include spatial/temporal median filter based de-interlacing, motion adaptive de-interlacing, and motion compensated de-interlacing. None of these approaches is completely satisfactory for all applications. Depending upon the approach taken and the video information content, blurred edges and other visually obvious processing artifacts often mar the resultant image.

A need therefore exists for a way to reliably and effectively de-interlace video information. Preferably the resultant information should be amenable to progressive display presentation and processing. Further, undue processing demands should not accompany the process.

### BRIEF DESCRIPTION OF THE DRAWINGS

These and other needs are substantially met through provision of the method for de-interlacing video information as described herein. These and other benefits will become more clear upon making a thorough review and study of the following detailed description of various embodiments configured in accordance with the invention, particularly when studied in conjunction with the drawings, wherein:

FIG. 1 comprises a prior art depiction of interlaced video information;

FIG. 2 comprises a flow diagram configured in accordance with various embodiments of the invention;

FIGS. 3 through 9 comprise depictions of manipulation of video information in accordance with various embodiments of the invention;

FIG. 10 comprises a flow diagram configured in accordance with various embodiments of the invention; and

FIGS. 11 through 13 comprise depictions of manipulation of video information in accordance with various embodiments of the invention.

### DETAILED DESCRIPTION

A first group of visual information and a second group of visual information (wherein these groups together comprise a single frame of interlaced visual information and wherein the second group of visual information is temporally displaced with respect to the first group of visual information) is provided. Additional visual information is added to a selected one of these groups of information to provide a quantity of data that constitutes a full frame of visual information. That additional visual information is then repeatedly compared against the unselected group of visual information to detect and metricize motion as has occurred during the window of temporal displacement. That motion information is then used to select specific information from the unselected group of visual information. That selected specific information includes a plurality of information items that are combined and processed to yield new items of visual information that are combined with the selected group of visual information to form a de-interlaced first frame of visual information.

The previously unselected group of visual information is then selected and the process repeated to form a de-interlaced second frame of visual information.

As a result, one frame of interlaced video information yields two frames of de-interlaced visual information. The resultant frames of de-interlaced visual information are considerably sharper and stable than the original frame of interlaced video information, when played back at the field rate (twice the frame rate) of the original interlaced video. A net effect of this approach is to create two frames of de-interlaced visual information wherein the data comprising each frame tends to be of a temporal whole as compared to the interlaced frame which tends to be comprised of two temporally distinct parts.

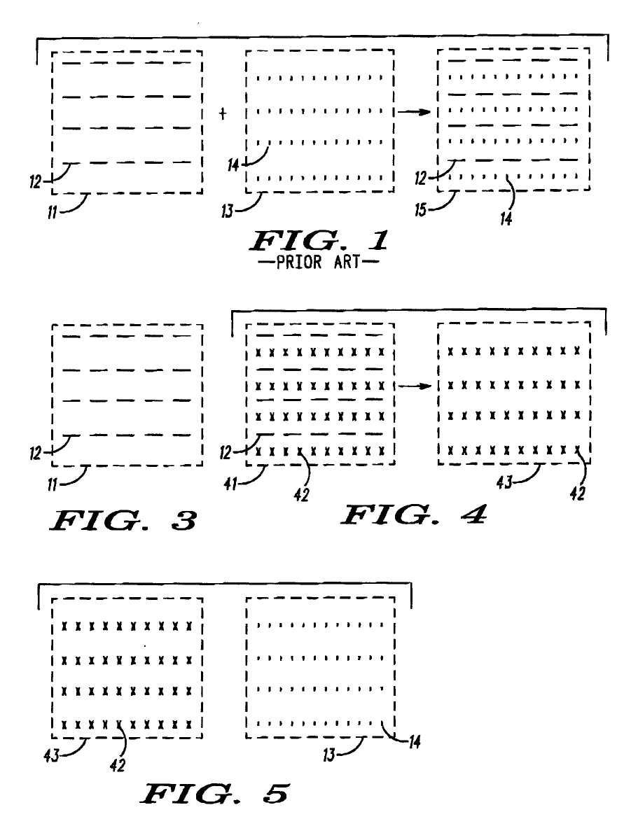

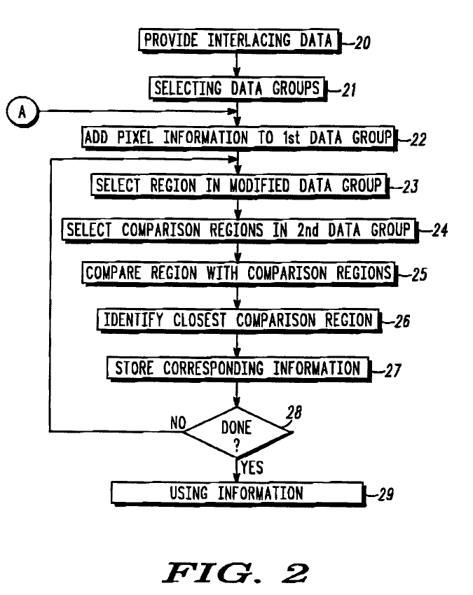

Various ways of achieving such results will now be described in more detail. Referring now to FIG. 2, the process begins by providing 20 interlacing video information. For example, and referring again to FIG. 1, the interlacing video information can be comprised of first field data 11 and second field data 13. The first field data 11 can be comprised of a plurality of pixel lines that represent, for example, top/odd lines of video information. The second field data 13 can be comprised of a plurality of pixel lines that represent, for example, bottom/even lines of video information. As noted above, the second field data 13 represents visual information that is temporally displaced with respect to the first field data 11. Also, the first and second field data 11 and 13 constitute, in this example, a full ordinary frame of interlaced video information.

One of these two field data 11 and 13 is selected 21 to provide a selected field data to serve as the basis for a first frame of de-interlaced video information. The remaining field data will serve as reference field data for purposes described below. Therefore, if the first field data 11 is selected, the second field data 13 will serve as reference field data. Similarly, if the second field data 13 is selected, the first field data 11 will serve as reference field data. By way of further example, if the first field data 11 is comprised of top pixel lines and the second field data 13 is comprised of bottom pixel lines, then selecting the first field data 11 will serve to initially select the top pixel lines to serve as the basis for a first frame of de-interlaced video information and further to identify the bottom pixel lines to serve as reference field data. For purposes of describing these processes within the context of an illustrative example, we shall presume that the first field data 11 constitutes this initially selected field data as depicted in FIG. 3.

As depicted in FIG. 2, the process next adds 22 pixel information to this selected data group comprising field data. As shown in FIG. 4, this additional pixel information 42 comprises, in this embodiment, additional lines of pixels that are interleaved between pairs of pixel lines 12 that comprise the selected field data. By adding such additional pixels, sufficient additional visual information is added to yield a quantity of visual information that comprises a full frame 41 of visual information. The pixel information 42 added is derived, in this embodiment, by considering the field data 12 itself. Vertical filtering of the field data 12 information constitutes one way to derive the additional pixel information 42 (vertical filtering is well understood in the art and hence additional elaboration will not be provided here for the sake of clarity and brevity). This added pixel information 42, viewed in isolation, constitutes modified field data 43. Usually, this modified field data 43 will not yield satisfactory results if used as is to interleave with the first field data 11 (even though together these fields constitute a full frame of progressive video information). Instead, usually additional processing as described below will provide better results.

With reference to FIG. 5, such additional processing makes use of the modified field data 43 and the reference field data 13 as identified earlier. It should be noted that both fields 43 and 13 are comprised of pixel lines 42 and 14 that are both characterized as being of common interlacing type (in other words, they are of the same polarity). For example, as illustrated, the pixel lines 42 and 14 are all bottom/even lines as viewed with respect to interlacing.

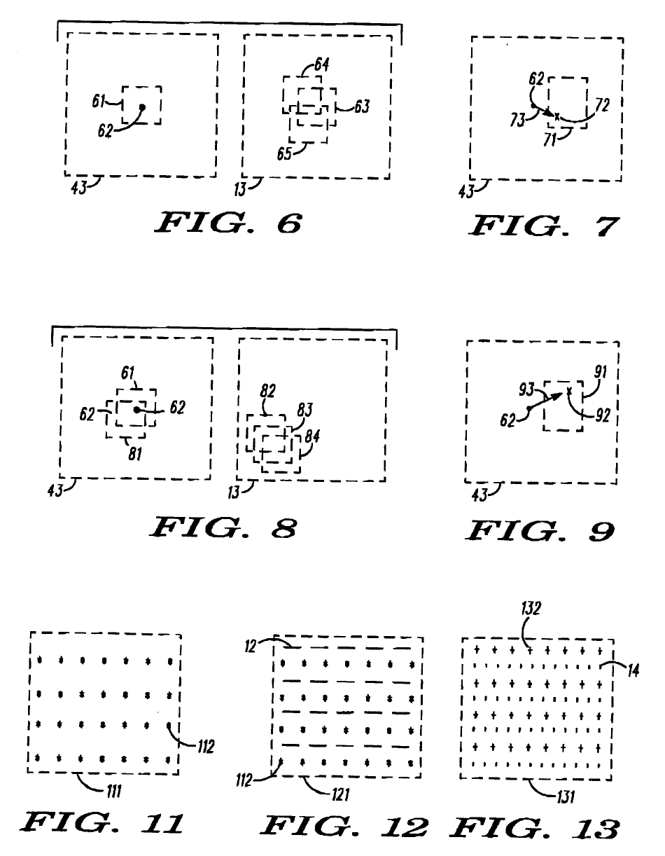

Referring again to FIG. 2, a region within the modified field data is selected 23. As shown in FIG. 6, the region 61 comprises a contiguous area defined by a boundary. A plurality of pixels are included within this region 61 (for purposes of clarity, only a single pixel 62 has been depicted). The size of the region 61 can be selected to suit various limitations and/or capabilities that are inherent to a particular application. In this particular embodiment, the region 61 comprises an 8 by 8 pixel array. The region 61 can be located virtually anywhere within the modified field data 43 as this constitutes an iterative process and eventually all portions of the modified field data 43 will be similarly treated.

Following selection 23 of the region 61 in the modified field data 43, a plurality of comparison regions are selected 24 in the reference field data 13. Three such comparison regions 63, 64, and 65 are depicted in FIG. 6. The number of regions can be modified to suit various performance requirements and limitations. In one specific embodiment, nine such regions have been found to be beneficial. Again, these regions comprise a plurality of pixels. Generally speaking, it is helpful if these regions are each of substantially identical size and further substantially equal in size to the region 61 as selected for the modified data field 43. Therefore, when selecting an 8 by 8 pixel array as the modified data field region 61, these reference field regions 63, 64, and 65 should also, in at least an ordinary application, comprise an 8 by 8 pixel array. In addition, it will also often be appropriate to select one of the reference field regions 63 to have a same relative location within the reference field data 13 as the modified field region 61 has within the modified field data 43. Also, it will usually be appropriate to select the reference field regions 63, 64, and 65 so that there is at least some overlap between the regions (it is not particularly necessary that all regions overlap with all other regions).

Each reference field region 63, 64, and 65 is then compared 25 with the modified field region 61 as specified in FIG. 2. A basic purpose for making this comparison is to identify 26 that reference field region that most closely corresponds to the modified field region 61 and to thereby establish some measure that correlates to potential movement of objects as rendered by the pixels that comprise these regions. This comparison of content can comprise a pixel by pixel comparison (which task is usually rendered easier when both regions being compared are of a similar size and shape such that they have a substantially identical number of pixels located in substantially identical relative positions with respect to one another). Upon identifying that reference field region that most closely compares to the modified field region 61, a measure of the vertical and horizontal displacement in relative position between these two regions is taken. For example, and referring now to FIG. 7, the pixel 62 having a specific location within the modified field region 61 as disclosed earlier is separated by a reference field region pixel 72 having a corresponding position within the reference field region 71 by a particular vertical and horizontal displacement. The vertical and horizontal displacement can be conveniently represented by a motion vector 73 although other conventions could be utilized as well if desired. (As depicted, the motion vector 73 is only shown in conjunction with the modified field pixel 62 location and the corresponding reference field pixel 72 location. In fact, the same motion vector 73 (or other corresponding motion information) is applied to all pixels within the corresponding region 61.)

In a preferred embodiment, the motion vector 73 is represented by a pair of floating-point numbers that represent the vertical and horizontal components of the relative displacement. In the case of a non-integer motion vector, four nearest neighbor pixels of the position pointed to by the motion vector in the reference field are used to interpolate a corresponding value for the pixel 72. (Interpolation for fractional motion vectors is well understood in the art and hence additional elaboration will not be provided here for the sake of clarity and brevity.)

It is important to note that although this particular reference field region 71 represents that reference field region that most closely corresponds in content with the modified field region 61, often this reference field region 71 will not be identical on a pixel by pixel basis with the modified field region 61. Consequently, an important result of this comparison is to specifically identify the reference field pixel 72 that corresponds to the like positioned pixel 62 in the modified field region 61. This reference field pixel 72 may therefore well have a pixel value that differs from the modified field pixel 62.

Corresponding information regarding this comparison is stored 27. Pursuant to one embodiment, the pixel values for pixels in the specifically identified reference field region 71 comprise the stored information. In another embodiment, the motion vector 73 (or other specific metrics regarding the measured motion) can be stored such that the reference field pixel values can be later retrieved when needed.

The process next determines whether this data gathering activity has concluded 28. Pursuant to one embodiment, the above described process will be repeatedly exercised until all areas within the modified field 43 have been processed once in this way. In a preferred embodiment, the above described process is repeatedly exercised until at least most areas within the modified field 43 have been processed a plurality of times. For example, it has been found advantageous to select overlapping modified field regions such that most or all pixels within the modified field data 43 are subject to comparative testing as described a total of four times. For example, as depicted in FIG. 8, a newly selected modified field region 81 can overlap with the previously selected region 61 such that at least one pixel 62 is common to both regions 61 and 81. The process then continues as before such that the newly selected modified field region 81 is compared against a plurality of reference field regions (three such regions 82, 83, and 84 are depicted for purposes of clarity but again a greater or lesser number of such regions could be utilized) to identify a particular reference field region that compares most closely to the modified field region 81. As depicted in FIG. 9, the extent of the difference between these two regions is measured (again represented here by a motion vector 93) such that pixels (such as the pixel represented by reference numeral 92) in the reference field data 13 can be identified as corresponding to pixels (such as the pixel represented by a reference numeral 62) in the modified field data 43. Again, the relevant information (pixel values or motion information sufficient to allow subsequent identification of the pixel values) are stored.

The reason for overlapped region partition at the modified field is to improve the reliability for motion estimation by providing better region partition. Without overlapping, it is likely that there are regions that include both a moving object and background, and neither the moving object nor the background dominates in terms of pixel count in the region. For such regions, it is difficult to obtain a correct motion vector because the object and the background may have their own independent motion. Overlapped region partition, although conducted without any knowledge of the scene and object segmentation information, increases the chance that for a region, either the object or the background dominates in terms of pixel count in the region. Consequently, for such a region that one type of information dominates, a more reliable motion vector can be measured.

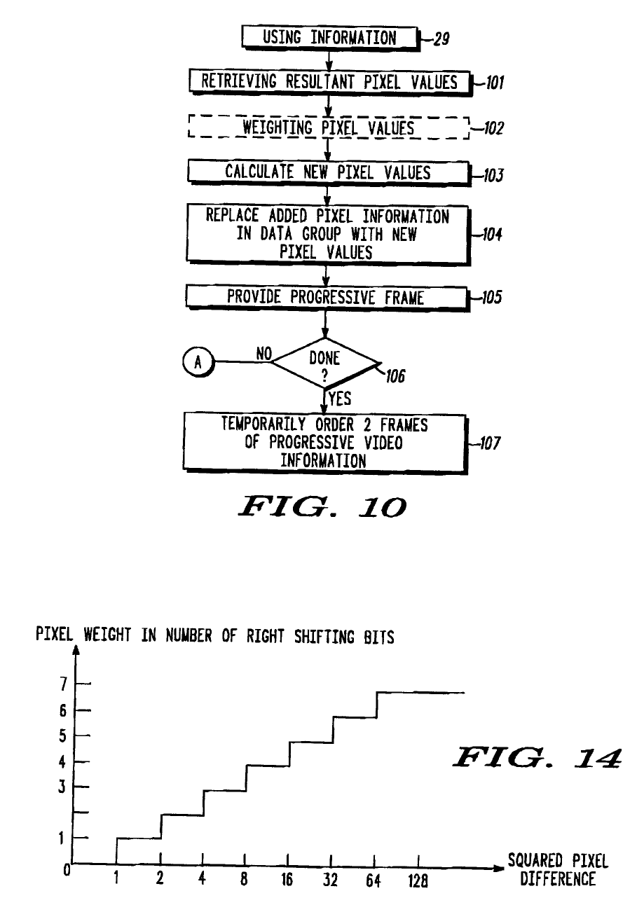

When the iterative comparative process has concluded 28, the process uses 29 the gathered information to effect fabrication of a progressive video data frame. Referring now to FIG. 10, various embodiments to so utilize such information will be described.

The pixel values as result from correlating specific reference field pixels to modified field pixels as a function of the motion vector as determined through the comparative process described above are retrieved 101 (if previously identified and stored, then that retrieval comprises accessing this stored data; otherwise, the motion information can be utilized at this time to identify the relevant pixel values). As described above, in one embodiment, the above comparative process is iterated four times for each pixel within the modified field data 43. As a result, for each pixel in the modified field data 43, typically four separate pixels, each having its own pixel value, will have been identified (or interpolated if the motion vector is non-integer) in the reference field 13 as being a closest fit and each such reference field pixel will have a corresponding vertical and horizontal displacement from the relative position of the pixel in the modified field region 61.

These four corresponding pixel values can optionally be weighted 102. For example, the pixel value associated with a reference field region that was closest in content to the corresponding pixel in the modified field region can be weighted more heavily than the remaining pixel values. (For example, for each pixel value in the modified region, four reference pixel values can be found using four motion vectors associated with this pixel; weights can be assigned that are proportional to the absolute difference between the reference pixel value and the value of this pixel.) Conversely, or in addition, the pixel value associated with a reference field region that was furthest in content to the corresponding pixel in the modified field region (that is, the pixel value having the largest difference among the four corresponding pixel values) can be weighted less heavily, left unweighted, or reduced in value with respect to the remaining pixel values. Also, if desired, each of the four corresponding pixel values can be weighted in correlation to the motion compensation information. One particular approach to obtain pixel weighting value wherein a squared compensation error (pixel value difference between the pixels denoted by reference numerals 62 and 72, for instance) for a current pixel is mapped to a weighting value is represented in FIG. 14. This mapping is designed to facilitate pixel weighting by means of right bit shifting (which is equivalent to dividing the pixel value by a number of two's power) and assigning relatively very little weight for pixels with a larger pixel value difference. One purpose of this mapping is to reduce the hardware cost for the multiplication of wᵢpᵢ, by converting the multiplication into bit shifting.

Using these resultant corresponding pixel values (weighted or unweighted as appropriate to the application) new pixel values are calculated. For example, for each pixel in the modified field data 43, the four reference field pixel values that correspond to that pixel as described above can be averaged or a mean or median value calculated. One way of expressing this approach is represented by the equation:

$${p}_{out} = \frac{{\sum }_{i = 0}^{3} {w}_{i} {p}_{i}}{{\sum }_{i = 0}^{3} {w}_{i}}$$

In this equation, pₒᵤₜ represents the resultant motion compensated value for a specific modified field pixel. pᵢ represents a motion compensated pixel value as identified using the corresponding motion vector. wᵢ represents a weighting coefficient (which may be represented by a “1” if no weighting is being used). This equation represents four corresponding pixel values that are utilized to calculate a resultant compensated value for a specific modified field pixel.

The new pixel values can then replace 104 the pixels in the modified field data such that a motion compensated field data 111 comprised of these new pixel values 112 will result as depicted in FIG. 11. Using this motion compensated field data 111, a single progressive frame can be provided 105. For example, with reference to FIG. 12, the compensated field data pixels 112 can be interleaved with the original selected field data 12 (which in this instance comprise the top/odd pixel lines as originally provided). By combining these pixels in this way, a complete frame 121 of progressive video information results.

Referring again to FIG. 10, the process will determine whether it has concluded 106. In the example given, the process has not concluded and the process would repeat itself with the only difference being that the previously unselected originally supplied field data will now be selected such that the previously selected field data with now be used as reference data. In the example given, the first iteration of the process fabricated bottom/even pixels to interleave with the original top/odd pixels to yield the progressive frame depicted in FIG. 12. A second iteration as described will fabricate top/odd pixels 132 to interleave with the original bottom/even pixels 14 to yield the progressive frame 131 depicted in FIG. 13. The process is therefore seen to yield two successive progressive frames of video information for each original frame of interlaced video information. Unless there was no object movement contained within the video information, these two resultant frames are unlikely to be identical to one another. Instead, the first frame 121 will be optimized for the image information as represented by the temporal conditions of the original top/odd information and the second frame 131 will be optimized for the image information as a represented by the temporal displaced conditions of the original bottom/even information. Because of this temporal distinction, the two frames 121 and 131 should of course be temporally ordered 107 as indicated in FIG. 10. As a result of this process, both frames will provide a more distinct and clear presentation of the video information.

Generally, the above process works well to estimate missing lines. On occasion, however, performance may be less exemplary for various reasons, including: the search range for motion estimation may not be large enough for a particular degree of motion; a given area may be suddenly uncovered or occluded due to a significant and/or large-scale motion; or a seriously aliased spatial pattern may result due to sub-sampling within a field. To generate a robust de-interlaced video image, it may be appropriate to detect that a non-ideal motion compensation has occurred. A comb pattern detection approach can be utilized to detect or assess for quality motion compensation. For example, when pixels are from a same depicted object, the difference between the summed values over alternating pixels in vertical dimension should be relatively close. If a significant difference becomes observable, then the pixels being tested may in fact be stemming from different objects and hence the resultant pixel values may not be appropriate. Upon detecting such an occurrence, for example, the process can simply utilize the vertically interpolated values as developed earlier in the process in substitution for the otherwise calculated pixel values.

Through use of these processes, standard interlaced video information can be readily and effectively converted or translated into video information that will readily support progressive display. The resultant images are considerably sharper and stable for motion portrayal. The process can be readily supported by dedicated hardware, software, or a combination thereof thereby making it usable in a wide variety of applications.

In addition to those various embodiments and alternatives noted above, additional alterations, modifications, and combinations will be evident to those skilled in the art. Such alterations, modifications, and combinations are to be considered as within the spirit and scope of the invention.

I claim:

1. A method for converting interlacing video information into progressive video information, comprising:
providing first interlacing field data comprising a plurality of pixel lines;
providing second interlacing field data comprising a plurality of pixel lines which second interlacing field data is temporally displaced from the first interlacing field data;
selecting one of the first and second interlacing field data to be a selected interlacing field data and a remaining one of the first and second interlacing field data to be a reference interlacing field data;
adding additional pixel information to the selected interlacing field data, which additional pixel information comprises modified interlacing field data;
selecting a first region comprising a plurality of pixels in the modified interlacing field data;
selecting a first plurality of comparison regions, each comprising a plurality of pixels, in the reference interlacing field data;
comparing each comparison region of the first plurality of comparison regions with the first region to identify a first comparison region that most closely corresponds to the first region;
selecting a second region comprising a plurality of pixels in the modified interlacing field data, which second region partially overlaps with the first region;
selecting a second plurality of comparison regions, each comprising a plurality of pixels, in the reference interlacing field data;
comparing each comparison region of the second plurality of comparison regions with the second region to identify a second comparison region that most closely corresponds to the second region;
using at least information corresponding to the first comparison region and the second comparison region to convert the selected interlacing field data into progressive video information.

2. The method of claim 1 wherein:
providing first interlacing field data comprises providing one of top and bottom field data; and
providing second interlacing field data comprises providing field data having a polarity opposite that chosen as the first interlacing field data.

3. The method of claim 1 wherein adding additional pixel information to the selected interlacing field data at least comprises adding an additional line of pixels between pairs of pixel lines that comprises the selected interlacing field data.

4. The method of claim 3 wherein adding an additional line of pixels between pairs of pixel lines that comprises the selected interlacing field data comprises using vertical filtering to select at least some of the pixels that comprise the additional lines of pixels.

5. The method of claim 1 wherein selecting a first region comprising a plurality of pixels in the modified interlacing field data includes selecting an 8 by 8 pixel array.

6. The method of claim 5 wherein selecting a first plurality of comparison regions in the reference interlacing field data includes selecting a first plurality of comparison regions wherein each of the comparison regions comprises an 8 by 8 pixel array.

7. The method of claim 1 wherein selecting a first plurality of comparison regions, each comprising a plurality of pixels, in the reference interlacing field data includes selecting a first comparison region that has a same relative location in the reference interlacing field data as the first region has in the modified interlacing data field.

8. The method of claim 7 wherein selecting a first plurality of comparison regions, each comprising a plurality of pixels, in the reference interlacing field data further includes selecting a plurality of additional comparison regions wherein at least some of the additional comparison regions partially overlap the first comparison region.

9. The method of claim 1 wherein comparing each comparison region of the first plurality of comparison regions with the first region to identify a first comparison region that most closely corresponds to the first region includes determining a first motion vector that represents estimated motion between at least some pixels in the modified interlacing field data and the reference interlacing field data.

10. The method of claim 9 wherein the first motion vector is assigned to each pixel within the first region.

11. The method of claim 10 wherein determining a first motion vector includes determining vertical and horizontal displacement between the first region and the first comparison region.

12. The method of claim 1 wherein comparing each comparison region of the second plurality of comparison regions with the second region to identify a second comparison region that most closely corresponds to the second region includes determining vertical and horizontal displacement between the second region and the second comparison region to determine a second motion vector that represents estimated motion between the first interlacing field data and the second interlacing field data.

13. The method of claim 12 wherein the second motion vector is assigned to each pixel within the second region such that at least one pixel that is a part of both the first region and the second region has both the first motion vector and the second motion vector assigned thereto.

14. The method of claim 13 wherein using at least information corresponding to the first comparison region and the second comparison region to convert the selected interlacing field data into progressive video information includes:
selecting a pixel in the modified interlacing field data, which pixel has a specific respective location within the modified interlacing field data;
identifying a corresponding pixel in the reference interlacing field data having a same specific respective location within the reference interlacing field data as the pixel has within the modified interlacing field data;
using the corresponding pixel and the first motion vector to identify a first resultant corresponding pixel having a first pixel value;
using the corresponding pixel and the second motion vector to identify a second resultant corresponding pixel having a second pixel value;
using at least the first and second pixel values to determine a new pixel value for the selected pixel;
using the new pixel value for the selected pixel in the modified interlacing field data.

15. The method of claim 14 wherein using at least the first and second pixel values includes weighting at least one of the first and second pixel values.

16. The method of claim 15 wherein weighting at least one of the first and second pixel values includes weighting more heavily that pixel value that corresponds to a motion vector that corresponds to a smallest difference between a pixel in the selected modified interlacing field data and a corresponding pixel in the reference interlacing field data.

17. A method for converting interlacing video information into progressive video information, comprising:
providing a group of top field lines and a group of bottom field lines;
selecting one of the groups to be a selected group and a remaining group to be a reference group;
adding additional line information to the selected group to provide a modified selected group;
selecting a first region in the modified selected group;
selecting a first plurality of comparison regions in the reference group;
comparing each comparison region with the first region to identify a particular comparison region that most closely corresponds in content to the first region;
selecting a second region in the modified selected group which second region at least partially overlaps with the first region;
selecting a second plurality of comparison regions in the reference group;
comparing each comparison region of the second plurality of comparison regions with the second region to identify a particular second comparison region that most closely corresponds in content to the second region;
using at least information corresponding to the particular comparison region and the particular second comparison region to convert the selected group of field lines into progressive video information.

18. The method of claim 17 wherein:
selecting a first plurality of comparison regions in the reference group includes selecting a first comparison region that has a same relative location in the reference group as the first region has in the modified selected group, and wherein at least some of the first plurality of comparison regions partially overlap the first comparison region; and
selecting a second plurality of comparison regions in the reference group includes selecting a second comparison region that has a same relative location in the reference group as the second region has in the modified selected group, and wherein at least some of the second plurality of comparison regions partially overlap the second comparison region.

19. A method comprising:
providing a first group of visual information and a second group of visual information wherein the first group and second group together comprise a quantity of data equaling at least approximately one frame of visual information and wherein the first group of visual information is temporally displaced with respect to the second group of visual information;
adding visual information to at least one of the first and second group of visual information to provide a frame of visual information;
identifying a plurality of information item groups in the frame of visual information wherein each information item group contains a unique group of information items and where each information item group also includes at least one shared information item;
estimating movement by comparing each of the information item groups against reference visual information to determine motion vectors that correspond to differences between the information item groups and the reference visual information.

20. The method of claim 19 and further comprising using the motion vectors to identify new pixel values.

21. The method of claim 20 wherein using the motion vectors to identify new pixel values includes weighting at least one of the new pixel values.

22. The method of claim 21 wherein weighting at least one of the new pixel values includes weighting a new pixel value that corresponds to a motion vector that corresponds to an information item group that least differs from the reference visual information.

23. The method of claim 19 wherein identifying a plurality of information item groups includes identifying multiple pluralities of information groups in the frame of visual information wherein each plurality of information groups includes information groups that each contain a unique group of information items and where each also includes at least one shared information item, and wherein each plurality of information groups includes information items that are unique to that plurality of information groups.

24. A method for converting interlacing video information into progressive video information, comprising:
providing a frame of video information comprised of a plurality of odd lines of pixels and a plurality of even lines of pixels, which lines are interleavable to thereby provide a single frame of interlaced video information;
selecting one of the plurality of odd lines and even lines to be a first selected group and a remaining plurality to be a first reference group;
adding additional line information to the first selected group to provide a modified first selected group;
selecting a first region in the modified first selected group;
selecting a first plurality of comparison regions in the first reference group;
comparing each comparison region in the first reference group with the first region in the modified first selected group to identify a particular comparison region in the first reference group that most closely corresponds in content to the first region in the modified first selected group;
selecting a second region in the modified first selected group which second region in the modified first selected group at least partially overlaps with the first region in the modified first selected group;
selecting a second plurality of comparison regions in the first reference group;
comparing each comparison region of the second plurality of comparison regions in the first reference group with the second region in the modified first selected group to identify a particular second comparison region in the first reference group that most closely corresponds in content to the second region in the modified first selected group;
using at least information corresponding to the particular comparison region in the first reference group and the particular second comparison region in the first reference group to convert the plurality of lines of pixels in the first selected group into a first frame of progressive video information;
selecting whichever of the plurality of odd lines and even lines as was previously selected to be the first reference group to be a second selected group and selecting whichever of the plurality of odd lines and even lines as was previously selected to be the first selected group to be a second reference group;
adding additional line information to the second selected group to provide a modified second selected group;
selecting a first region in the modified second selected group;
selecting a first plurality of comparison regions in the second reference group;
comparing each comparison region in the second reference group with the first region in the modified second selected group to identify a particular comparison region in the second reference group that most closely corresponds in content to the first region in the modified second selected group;
selecting a second region in the modified second selected group which second region in the modified second selected group at least partially overlaps with the first region in the modified second selected group;
selecting a second plurality of comparison regions in the second reference group;
comparing each comparison region of the second plurality of comparison regions in the second reference group with the second region in the modified second selected group to identify a particular second comparison region in the second reference group that most closely corresponds in content to the second region in the modified second selected group;
using at least information corresponding to the particular comparison region in the second reference group and the particular second comparison region in the second reference group to convert the plurality of lines of pixels in the second selected group into a second frame of progressive video information;
such that two frames of progressive video information are thereby provided.
